(19) United States
(12) Patent Application Publication
(10) Pub. No.: US 2026/0361085 A1
(43) Pub. Date: Nov. 12, 2026

(54) POWER SUPPLY CIRCUIT AND ENERGY STORAGE SYSTEM

(71) Applicant: SHENZHEN HELLO TECH ENERGY CO., LTD, Shenzhen (CN)

(72) Inventors: Qingbin LIN, Shenzhen (CN); Gaosong SHEN, Shenzhen (CN); Feiyan LUO, Shenzhen (CN); Wenhai LIN, Shenzhen (CN); Hongliang ZHAO, Shenzhen (CN)

(21) Appl. No.: 19/726,870

(22) Filed: Jun. 30, 2026

(30) Foreign Application Priority Data
Jul. 28, 2025 (CN) 202511046082.8

(51) Int. Cl. H02J 3/32; H02J 3/007; H02M 1/00

(52) U.S. Cl. CPC H02J 3/32; H02J 3/007; H02M 1/0067

(57) ABSTRACT

Provided are a power supply circuit and an energy storage system. The power supply circuit includes first and second alternating current-direct current conversion modules, and first, second, and third output interfaces. The first and second output interfaces are connected to the first and second alternating current-direct current conversion modules, respectively. The second output interface is connected to the first output interface by a first switch. In a first state, the first switch is switched on, and first and second alternating currents generated by the first and second alternating current-direct current conversion modules are outputted through the first and/or second output interfaces. In a second state, the first switch is switched off, the first output or second interface is disconnected from the first or second alternating current-direct current conversion module respectively, and the first and second alternating currents are outputted through the third output interface.

### CROSS-REFERENCE TO RELATED APPLICATION

This application claims priority to Chinese Patent Application No. 202511046082.8, filed with China National Intellectual Property Administration on Jul. 28, 2025, the entire contents of which are incorporated herein by reference.

### FIELD

The present disclosure relates to the technical field of energy storage, and in particular, to a power supply circuit and an energy storage system.

### BACKGROUND

A portable/mobile energy storage system typically incorporates a high-energy-density battery group (such as a lithium-ion battery) and converts a direct current into an alternating current through an inverter for power output. Such a system is designed with an emphasis on portability, safety, and multi-scenario applicability (such as outdoor activities, emergency backup, and off-grid power supply), with the core function being to provide a flexible and reliable alternating current power supply.

Currently, the portable/mobile energy storage system may provide alternating current output through alternating current interfaces, commonly available in single-phase (L/N) and two-phase (L1/L2/N) configurations. In the single-phase configuration, output power of the alternating current interface is rated as PL (i.e., a total system power). In the two-phase configuration, output power of a single phase wire interface (L1 or L2) is rated as PL1 or PL2. When both phase wire interfaces are used simultaneously, a total output power of the two phase wire interfaces is PL1+PL2 (i.e., the total system power).

For a two-phase energy storage system, an output capability of any single-phase interface (L1 or L2) is typically designed to be half of the total system power (PL1+PL2). This means that, using a single-phase interface alone, the output power can reach a maximum of 50% of the system's maximum design power, making it difficult to deliver the system's full maximum power through a single interface.

### SUMMARY

Embodiments of the present disclosure provide a power supply circuit and an energy storage system.

The power supply circuit according to an embodiment of the present disclosure includes: a first alternating current-direct current conversion module configured to generate a first alternating current; a second alternating current-direct current conversion module configured to generate a second alternating current; a first output interface configured to be electrically connected to the first alternating current-direct current conversion module; a second output interface configured to be electrically connected to the second alternating current-direct current conversion module and connected to the first output interface by a first switch; and a third output interface having a first connection terminal and a second connection terminal. The first connection terminal is connectable to the first alternating current-direct current conversion module, and the second connection terminal is connectable to the second alternating current-direct current conversion module. In a first state, the first switch is switched on, the first alternating current and the second alternating current have the same amplitude without a phase difference between the first alternating current and the second alternating current, the first alternating current and the second alternating current are outputted through the first output interface and/or the second output interface, and the third output interface is disconnected from the first alternating current-direct current conversion module and the second alternating current-direct current conversion module. In a second state, the first switch is switched off, the first output interface is electrically disconnected from the first alternating current-direct current conversion module or the second output interface is electrically disconnected from the second alternating current-direct current conversion module, the phase difference exists between the first alternating current and the second alternating current, the third output interface is connected to both the first alternating current-direct current conversion module and the second alternating current-direct current conversion module, and the first alternating current and the second alternating current are outputted through the third output interface.

In some embodiments, the power supply circuit further includes a switch module including a first switch unit. An end of the first switch unit is connected to an alternating current power supply, and another end of the first switch unit is connected to the first output interface, the second output interface, and the first alternating current-direct current conversion module. When the first switch unit is switched on, a third alternating current is supplied to the first output interface, the second output interface, and the first alternating current-direct current conversion module from the alternating current power supply via the first switch unit.

In some embodiments, the switch module further includes: a second switch unit, in which an end of the second switch unit is connected to the first switch unit, the first alternating current-direct current conversion module, and the second alternating current-direct current conversion module, and another end of the second switch unit is connected to the first connection terminal and the second connection terminal, respectively; a third switch unit, in which an end of the third switch unit is connected to the first alternating current-direct current conversion module and the first switch unit, and another end of the third switch unit is connected to the first output interface; and a fourth switch unit, in which an end of the fourth switch unit is connected to the second alternating current-direct current conversion module and the first switch unit, and another end of the fourth switch unit is connected to the second output interface. In the first state, the first switch unit is switched off, and the third switch unit and/or the fourth switch unit are switched on. In the second state, the first switch unit is switched off, and the second switch unit is switched on.

In some embodiments, the first alternating current-direct current conversion module is further electrically connected to the second alternating current-direct current conversion module. In a third state, the first switch unit and the fourth switch unit are switched on, the third alternating current supplied from the alternating current power supply is rectified into a first direct current by the first alternating current-direct current conversion module, the first direct current is inverted into the second alternating current by the second alternating current-direct current conversion module, and the second alternating current is outputted to the second output interface and/or the first output interface through the fourth switch unit and/or the first switch.

In some embodiments, in a fourth state, the first switch unit and the third switch unit are switched on, the third alternating current is supplied to the third output interface and the first alternating current-direct current conversion module from the alternating current power supply, and the first alternating current-direct current conversion module is further configured to generate a first direct current from the third alternating current.

In some embodiments, the first switch unit includes: a second switch, in which an end of the second switch is connected to a live terminal of the alternating current power supply, and another end of the second switch is connected to a live terminal of the first alternating current-direct current conversion module and the third switch unit; and a third switch, in which an end of the third switch is connected to a neutral terminal of the alternating current power supply, and another end of the third switch is connected to a neutral terminal of the first alternating current-direct current conversion module and the third switch unit.

In some embodiments, the second switch unit includes: a fourth switch, in which an end of the fourth switch is connected to the live terminal of the first alternating current-direct current conversion module, and another end of the fourth switch is connected to the first connection terminal; a fifth switch, in which an end of the fifth switch is connected to a neutral terminal of the second alternating current-direct current conversion module, and another end of the fifth switch is connected to a neutral terminal of the third output interface; and a sixth switch, in which an end of the sixth switch is connected to a live terminal of the second alternating current-direct current conversion module, and another end of the sixth switch is connected to the second connection terminal of the third output interface.

In some embodiments, the third switch unit includes: a seventh switch, in which an end of the seventh switch is connected to the live terminal of the first alternating current-direct current conversion module and the second switch, and another end of the seventh switch is connected to a live terminal of the first output interface; and an eighth switch in which an end of the eighth switch is connected to the third switch and a neutral terminal of the second alternating current-direct current conversion module, and another end of the eighth switch is connected to a neutral terminal of the first output interface.

In some embodiments, the fourth switch unit includes a ninth switch. An end of the ninth switch is connected to a live terminal of the second alternating current-direct current conversion module, and another end of the ninth switch is connected to a live terminal of the second output interface.

In some embodiments, in the second state, the first alternating current and the second alternating current have the same amplitude, and the phase difference between the first alternating current and the second alternating current ranges from 90° to 180°.

In some embodiments, in the second state, the first alternating current and the second alternating current have the same amplitude, and the phase difference between the first alternating current and the second alternating current is 180°.

An energy storage system according to an embodiment of the present disclosure includes the power supply circuit according to any one of the above embodiments and a battery module. The first alternating current-direct current conversion module and the second alternating current-direct current conversion module are electrically connected to the battery module. The first alternating current-direct current conversion module and the second alternating current-direct current conversion module are configured to provide a direct current power supply to the battery module, or the battery module is configured to output an alternating current through the first alternating current-direct current conversion module and the second alternating current-direct current conversion module.

In the power supply circuit and the energy storage system according to the embodiments of the present disclosure, by configuring the first alternating current-direct current conversion module, the second alternating current-direct current conversion module, the first output interface, the second output interface, the third output interface, and the first switch, in the first state, since the first switch is switched on and the first alternating current-direct current conversion module and the second alternating current-direct current conversion module output alternating currents with the same phase and frequency, the first output interface and/or the second output interface can provide high-power single-phase alternating current output via superposition of the first alternating current and the second alternating current, such that output power is approximately a total output power of the first and second alternating current-direct current conversion modules; in the second state, since the first switch is switched off and the first output interface is electrically disconnected from the first alternating current-direct current conversion module or the second output interface is electrically disconnected from the second alternating current-direct current conversion module, the first alternating current and the second alternating current can be prevented from being combined and outputted through the first output interface or the second output interface, thereby avoiding damage to a load device. Meanwhile, the third output interface, with its two connection terminals connected to both the first and second alternating current-direct current conversion modules, can output a two-phase alternating current. In this way, a problem of limited power at a single output interface is effectively solved, while satisfying user's different demands for high-power single-phase output and split-phase power supply. Moreover, safety during split-phase power supply is ensured, significantly improving the adaptability and practicality of the energy storage system.

Additional aspects and advantages of the present disclosure will be in part set forth below, become apparent in part from the following description, or can be learned by practice of the present disclosure.

### BRIEF DESCRIPTION OF THE DRAWINGS

The above and/or additional aspects and advantages of the present disclosure will become apparent and readily understandable from the following description of embodiments taken in conjunction with the accompanying drawings.

FIG. 1 is a schematic module diagram of a power supply circuit according to some embodiments of the present disclosure;

FIG. 2 is a schematic diagram of a scenario of a power supply circuit in a first state according to some embodiments of the present disclosure;

FIG. 3 is a schematic diagram of a scenario of a power supply circuit in a second state according to some embodiments of the present disclosure;

FIG. 4 is a schematic diagram of a scenario of a power supply circuit in a third state according to some embodiments of the present disclosure; and

FIG. 5 is a schematic diagram of a scenario of the power supply circuit in a fourth state according to some embodiments of the present disclosure.

### REFERENCE NUMERALS

energy storage system 1000, power supply circuit 100, first alternating current-direct current conversion module 10, second alternating current-direct current conversion module 20, first output interface 30, second output interface 40, third output interface 50, switch module 60, first switch unit 61, second switch unit 62, third switch unit 63, fourth switch unit 64, first switch K1, second switch K2, third switch K3, fourth switch K4, fifth switch K5, sixth switch K6, seventh switch K7, eighth switch K8, ninth switch K9, battery module 200.

### DETAILED DESCRIPTION

The embodiments of the present disclosure will be described in detail below, examples thereof are illustrated in the accompanying drawings, throughout which same or similar elements, or elements having same or similar functions, are denoted by same or similar reference numerals. The embodiments described below with reference to the accompanying drawings are exemplary, only used to explain the present disclosure, and should not be construed as limitation of the present disclosure.

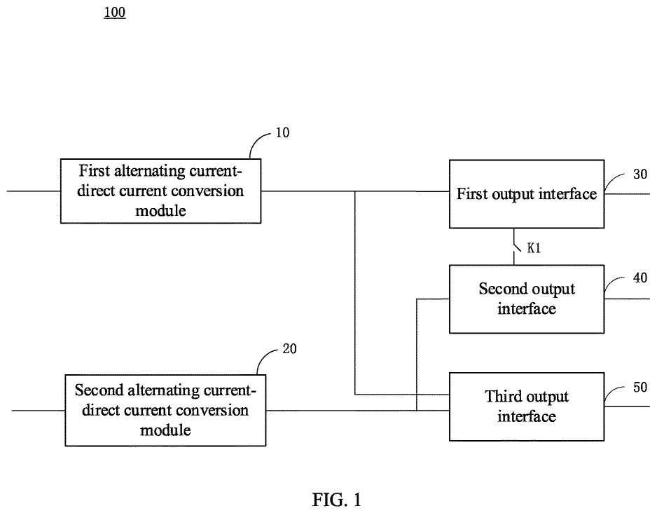

Referring to FIG. 1 to FIG. 5, an embodiment of the present disclosure provides an energy storage system 1000. The energy storage system 1000 includes a battery module 200 and a power supply circuit 100. The power supply circuit 100 is electrically connected to the battery module 200. The power supply circuit 100 is configured to provide a direct current power supply to the battery module 200, or the battery module 200 is configured to output an alternating current through the power supply circuit 100.

Further referring to FIG. 1, the power supply circuit 100 includes a first alternating current-direct current conversion module 10, a second alternating current-direct current conversion module 20, a first output interface 30, a second output interface 40, a third output interface 50, and a first switch K1. The first alternating current-direct current conversion module 10 is configured to generate a first alternating current. The second alternating current-direct current conversion module 20 is configured to generate a second alternating current. The first output interface 30 is configured to be electrically connected to the first alternating current-direct current conversion module 10. The second output interface 40 is configured to be electrically connected to the second alternating current-direct current conversion module 20 and connected to the first output interface 30 by the first switch K1. The third output interface 50 has a first connection terminal L1 and a second connection terminal L2. The first connection terminal L1 is connectable to the first alternating current-direct current conversion module 10, and the second connection terminal L2 is connectable to the second alternating current-direct current conversion module 20.

In a first state, the first switch K1 is switched on, the first alternating current and the second alternating current have the same amplitude without a phase difference between the first alternating current and the second alternating current, and the first alternating current and the second alternating current are outputted through the first output interface 30 and/or the second output interface 40. In a second state, the first switch K1 is switched off, the first output interface 30 is electrically disconnected from the first alternating current-direct current conversion module 10 or the second output interface 40 is electrically disconnected from the second alternating current-direct current conversion module 20, the phase difference exists between the first alternating current and the second alternating current, the third output interface 50 is connected to both the first alternating current-direct current conversion module 10 and the second alternating current-direct current conversion module 20, and the first alternating current and the second alternating current are outputted through the third output interface.

In the power supply circuit 100 and the energy storage system 1000 according to the embodiment of the present disclosure, by configuring the first alternating current-direct current conversion module 10, the second alternating current-direct current conversion module 20, the first output interface 30, the second output interface 40, the third output interface 50, and the first switch K1, in the first state, since the first switch K1 is switched on and the first alternating current-direct current conversion module 10 and the second alternating current-direct current conversion module 20 output alternating currents with the same phase and frequency, the first output interface 30 and/or the second output interface 40 can provide high-power single-phase alternating current output via superposition of the first alternating current and the second alternating current, such that output power is approximately a total output power of the first and second alternating current-direct current conversion modules; in the second state, since the first switch K1 is switched off and the first output interface 30 is electrically disconnected from the first alternating current-direct current conversion module 10 or the second output interface 40 is electrically disconnected from the second alternating current-direct current conversion module 20, the first alternating current and the second alternating current can be prevented from being combined and outputted through the first output interface 30 or the second output interface 40, thereby avoiding damage to a load device. Meanwhile, the third output interface 50, with its two connection terminals connected to both the first and second alternating current-direct current conversion modules, can output a two-phase alternating current. In this way, a problem of limited power at a single output interface is effectively solved, while satisfying user's different demands for high-power single-phase output and split-phase power supply, thereby enriching types of power supply loads. Moreover, safe output of the energy storage system 1000 during split-phase power supply is ensured, significantly improving the adaptability and practicality of the energy storage system 1000.

In an exemplary embodiment of the present disclosure, the energy storage system 1000 is a system that can convert electrical energy into other forms of energy for storage through a medium or device, and release the energy when desired. In this embodiment, the energy storage system 1000 may be a portable energy storage system. It should be noted that the portable energy storage system is a movable and easily carried energy storage and supply system.

The first alternating current-direct current conversion module 10 and the second alternating current-direct current conversion module 20 are configured to realize the conversion between the alternating current and the direct current. Both the first alternating current-direct current conversion module 10 and the second alternating current-direct current conversion module 20 may be bidirectional alternating current-direct current conversion modules. That is, the first alternating current-direct current conversion module 10 and the second alternating current-direct current conversion module 20 can convert the alternating current into the direct current, and can also convert the direct current into the alternating current. In some other embodiments, it should be understood that in other examples, the second alternating current-direct current conversion module 20 may also employ a unidirectional alternating current-direct current conversion module, and the second alternating current-direct current conversion module 20 can convert the direct current into the alternating current.

The first alternating current-direct current conversion module 10 and the second alternating current-direct current conversion module 20 may employ a DC/AC topological structure, or a multi-stage topological structure of DC/DC+DC/AC. For example, in some examples, the first alternating current-direct current conversion module 10 employs the DC/AC topological structure, and the second alternating current-direct current conversion module 20 employs the multi-stage topological structure of DC/DC+DC/AC. For another example, both the first alternating current-direct current conversion module 10 and the second alternating current-direct current conversion module 20 employ the multi-stage topological structure of DC/DC+DC/AC.

DC terminals (direct current terminals) of the first alternating current-direct current conversion module 10 and the second alternating current-direct current conversion module 20 are configured to be electrically connected to the battery module 200. AC terminals (alternating current terminals) of the first alternating current-direct current conversion module 10 and the second alternating current-direct current conversion module 20 are configured to be electrically connected to an external alternating current power supply or an output interface. The first alternating current-direct current conversion module 10 and/or the second alternating current-direct current conversion module 20 can provide the direct current power supply to the battery module 200, or the battery module 200 can output the alternating current through the first alternating current-direct current conversion module 10 and/or the second alternating current-direct current conversion module 20.

Further, the first alternating current-direct current conversion module 10 can invert the direct current outputted by the battery module 200 into the first alternating current, and the second alternating current-direct current conversion module 20 can invert the direct current outputted by the battery module 200 into the second alternating current. The first alternating current and the second alternating current may have the same amplitude, and the phase difference between the first alternating current and the second alternating current may range from 90° to 180°. The first alternating current-direct current conversion module 10 and/or the second alternating current-direct current conversion module 20 can also invert the alternating current inputted from the external alternating current power supply into the direct current, and transmit the direct current to the battery module 200, thereby charging the battery module 200.

The first output interface 30, the second output interface 40, and the third output interface 50 are connectable to a load to supply the alternating current to the load. Each of the first output interface 30 and the second output interface 40 is a single-phase interface including a live terminal and a neutral terminal, and is capable of outputting a single-phase alternating current. The third output interface 50 includes two live terminals and a neutral terminal. The third output interface 50 is a two-phase interface, and is capable of outputting the two-phase alternating current.

The first output interface 30 is configured to be electrically connected to the first alternating current-direct current conversion module 10, and the second output interface 40 is configured to be electrically connected to the second alternating current-direct current conversion module 20. In this way, the first alternating current is outputted by the first alternating current-direct current conversion module 10 through the first output interface 30, and the second alternating current-direct current conversion module 20 can be electrically connected to the second output interface 40 and output the second alternating current through the second output interface 40. The first output interface 30 and the second output interface 40 may also be connected by the first switch K1. When the first switch K1 is switched on, the first output interface 30 is connected to the second output interface 40, enabling the first alternating current and the second alternating current to be output through the first output interface 30 and/or the second output interface 40.

The first state may represent a state where the energy storage system 1000 provides high-power single-phase output, and the second state may represent a state where the energy storage system 1000 provides two-phase output. The energy storage system 1000 may further include a control module. The control module may be a controller, such as a Microcontroller Unit (MCU). The control module may be connected to the first alternating current-direct current conversion module 10, the second alternating current-direct current conversion module 20, and the first switch K1, respectively. The control module may be configured to control the output of each of the first alternating current-direct current conversion module 10 and the second alternating current-direct current conversion module 20, as well as switching-on and switching-off of the first switch K1, thereby bringing the energy storage system 1000 into the first state or the second state.

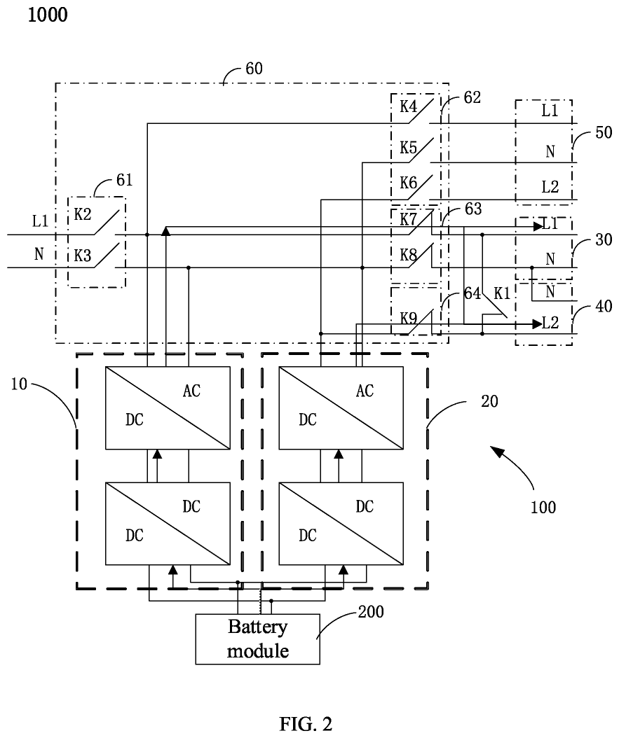

Further referring to FIG. 2, in the first state, the control module can control the first switch K1 to be switched on, thereby connecting the first output interface 30 and the second output interface 40 by the first switch K1. The control module also controls the first alternating current-direct current conversion module 10 to generate the first alternating current and the second alternating current-direct current conversion module 20 to generate the second alternating current. Moreover, the first alternating current and the second alternating current have the same amplitude without a phase difference between the first alternating current and the second alternating current. The first alternating current generated by the first alternating current-direct current conversion module 10 is transmitted to the first output interface 30, and further transmitted to the second output interface 40 by the first switch K1. The second alternating current generated by the second alternating current-direct current conversion module 20 is transmitted to the second output interface 40, and further transmitted to the first output interface 30 by the first switch K1. In this way, both the first output interface 30 and the second output interface 40 can output the alternating current superimposed from the first alternating current and the second alternating current to the load. It can be understood that, since the first alternating current and the second alternating current have the same amplitude without the phase difference between the first alternating current and the second alternating current, output power of the first output interface 30 and the second output interface 40 is a total output power of the first alternating current-direct current conversion module 10 and the second alternating current-direct current conversion module 20, i.e., PL1+PL2. In this way, a two-phase parallel output mode is realized to superimpose the output power of either phase, which can drive a larger load and maximize a capability of the energy storage system 1000.

For example, a voltage of each of the first alternating current and the second alternating current may be 120V, and the output power of each of the first alternating current-direct current conversion module 10 and the second alternating current-direct current conversion module 20 may be 2000 watts. In this way, in the first state, an output voltage of the first output interface 30 and/or an output voltage of the second output interface 40 is 120V, and the output power of the first output interface 30 and/or the output power of the second output interface 40 is 4000 watts.

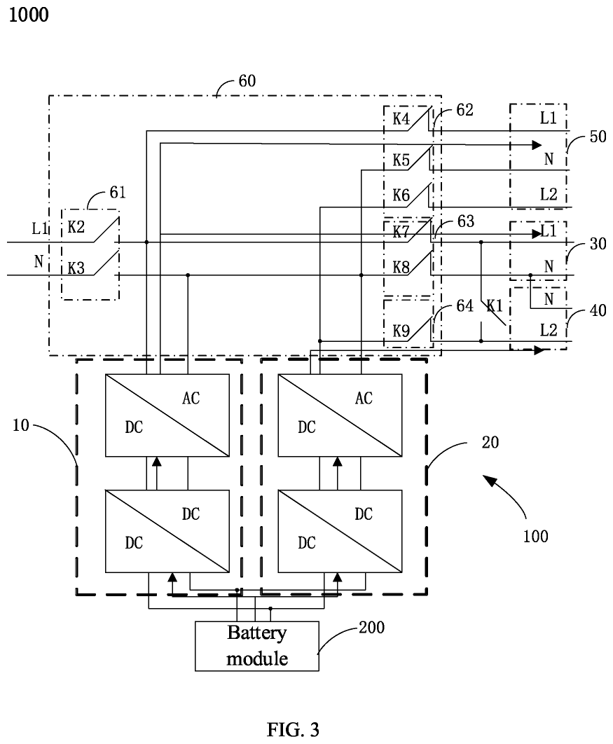

Referring to FIG. 3, in the second state, the control module can control the first switch K1 to be switched off, or control the first output interface 30 to be electrically disconnected from the first alternating current-direct current conversion module 10, or control the second output interface 40 to be electrically disconnected from the second alternating current-direct current conversion module 20, thereby preventing the first alternating current and the second alternating current from being combined and outputted through the first output interface 30 or the second output interface 40, which would result in damage to the load device. The control module can also control the first alternating current-direct current conversion module 10 to output the first alternating current to the first connection terminal L1 of the third output interface 50, and the second alternating current-direct current conversion module 20 to output the second alternating current to the second connection terminal L2 of the third output interface 50, enabling the two-phase alternating current to be outputted through the third output interface 50. The first alternating current and the second alternating current may have the same amplitude, and the phase difference between the first alternating current and the second alternating current may range from 0° to 180°. For example, the phase difference may be 0°, 45°, 90°, 135°, or 180°. That is, a range of the voltage outputted through the third output interface 50 may be 0 to 2 times a single-phase voltage, and a range of the power outputted through the third output interface 50 may be 0 to 2 times the maximum single-phase output power. In an exemplary embodiment of the present disclosure, the first alternating current and the second alternating current may have the same amplitude, and the phase difference between the first alternating current and the second alternating current may range from 90° to 180°. In this embodiment, in the second state, the phase difference between the first alternating current and the second alternating current is 180°. It can be understood that when the phase difference between the first alternating current and the second alternating current is 180°, the voltage and power outputted through the third output interface 50 both reach their maximum values. In this way, it is realized that the two-phase alternating current is outputted by the energy storage system 1000, which can adapt to a load with a higher voltage.

For example, the voltage of each of the first alternating current and the second alternating current may be 120V, and the output power of each of the first alternating current-direct current conversion module 10 and the second alternating current-direct current conversion module 20 may be 2000 watts. In this case, the range of the voltage outputted through the third output interface 50 may range from 0V to 240V, and the range of the power outputted through the third output interface 50 may range from 0 watts to 4000 watts. Moreover, when the phase difference between the first alternating current and the second alternating current is 180°, the voltage outputted through the third output interface 50 is 240V, and the power outputted through the third output interface 50 is 4000 W.

In addition, in the second state, the control module can control the first alternating current-direct current conversion module 10 to output the first alternating current to the first output interface 30, and/or control the second alternating current-direct current conversion module 20 to output the second alternating current to the second output interface 40, enabling the first alternating current to be outputted through the first output interface 30 and/or the second alternating current to be outputted through the second output interface 40. In this way, single-phase output and two-phase output of the energy storage system 1000 can be realized simultaneously.

In some embodiments, the power supply circuit 100 further includes a switch module 60. The switch module 60 includes a first switch unit 61. An end of the first switch unit 61 is connected to an alternating current power supply, and another end of the first switch unit 61 is connected to the first output interface 30, the second output interface 40, and the first alternating current-direct current conversion module 10. When the first switch unit 61 is switched on, a third alternating current is supplied to the first output interface 30, the second output interface 40, and the first alternating current-direct current conversion module 10 from the alternating current power supply via the first switch unit 61.

It should be noted that the alternating current power supply may be utility power. The first switch unit 61 is configured to control whether the energy storage system 1000 is connected to or disconnected from the alternating current power supply.

The first switch unit 61 includes a second switch K2 and a third switch K3. An end of the second switch K2 is connected to a live terminal of the alternating current power supply, and another end of the second switch K2 is connected to a live terminal of the first alternating current-direct current conversion module 10 and the third switch unit 63. An end of the third switch K3 is connected to a neutral terminal of the alternating current power supply, and another end of the third switch K3 is connected to a neutral terminal of the first alternating current-direct current conversion module 10 and the third switch unit 63. The control module may be connected to both the second switch K2 and the third switch K3, and control switching-on and switching-off of each of the second switch K2 and the third switch K3.

When the alternating current is supplied to the load by the energy storage system 1000 through the first output interface 30, the second output interface 40, or the third output interface 50, the control module can control the second switch K2 and the third switch K3 to be switched off, and control the first alternating current-direct current conversion module 10 to invert the direct current supplied by the battery module 200 into the first alternating current and the second alternating current-direct current conversion module 20 to invert the direct current supplied by the battery module 200 into the second alternating current. The alternating current is then supplied to the load through the first output interface 30, the second output interface 40, or the third output interface 50. When the alternating current is supplied to the load from the alternating current power supply through the first output interface 30, the second output interface 40, or the third output interface 50, the control module can control the second switch K2 and the third switch K3 to be switched on, thereby enabling the alternating current to be supplied to the load from the alternating current power supply through the first output interface 30 or the second output interface 40, or to charge the battery module 200 through the first alternating current-direct current conversion module 10.

In this way, through the arrangement of the first switch unit 61, intelligent switching and flexible selection of the connection of an external alternating current power supply and inverter power supply of the energy storage system 1000 are realized. When the first switch unit 61 is switched on, the external alternating current power supply is connected to the energy storage system 1000, and the third alternating current is directly supplied to the second output interface 40 and the first alternating current-direct current conversion module 10 simultaneously by the external alternating current power supply via the switch unit. In this way, direct and efficient power supply from the external alternating current to a critical output interface and an internal module is achieved, an input path of the external alternating current is simplified, and power supply efficiency and reliability of the energy storage system 1000 in a grid-connected state or a utility-power-available state are improved. Meanwhile, a channel for utility power charging or bypass operation is provided for the energy storage system 1000.

Further referring to FIG. 2 to FIG. 5, in some embodiments, the switch module 60 further includes a second switch unit 62, a third switch unit 63, and a fourth switch unit 64. An end of the second switch unit 62 is connected to the first switch unit 61, the first alternating current-direct current conversion module 10, and the second alternating current-direct current conversion module 20, and another end of the second switch unit 62 is connected to the first connection terminal L1 and the second connection terminal L2, respectively. The second switch unit 62 is configured to realize connection and disconnection between the third output interface 50 and the first alternating current-direct current conversion module 10 and the second alternating current-direct current conversion module 20. An end of the third switch unit 63 is connected to the first alternating current-direct current conversion module 10 and the first switch unit 61, and another end of the third switch unit 63 is connected to the first output interface 30. The third switch unit 63 is configured to realize connection and disconnection between the first output interface 30 and the first alternating current-direct current conversion module 10 and/or the first switch unit 61. An end of the fourth switch unit 64 is connected to the second alternating current-direct current conversion module 20, and another end of the fourth switch unit 64 is connected to the second output interface 40. The fourth switch unit 64 is configured to realize connection and disconnection between the second output interface 40 and the second alternating current-direct current conversion module 20. In the first state, the first switch unit 61 and the second switch unit 62 are switched off, and the third switch unit 63 and/or the fourth switch unit 64 are switched on. In the second state, the first switch unit 61, the third switch unit 63, or the fourth switch unit 64 is switched off, and the second switch unit 62 is switched on.

In this way, by introducing the second switch unit 62, the third switch unit 63, and the fourth switch unit 64, and coordinating their control with the first switch unit 61, the power supply circuit 100 can achieve refined management and safe isolation of output modes and power supply paths. In the first state, the electrical energy flows to the first output interface 30 only through the third switch unit 63 from the first alternating current-direct current conversion module, and/or flows to the second output interface 40 through the fourth switch unit 64 from the second alternating current-direct current conversion module. As a result, independent and controllable paths for the output of the alternating current-direct current conversion modules to designated single-phase interfaces are ensured. In the second state, the first and second alternating current-direct current conversion modules are respectively connected to the two connection terminals (L1/L2) of the third output interface 50 by the second switch unit 62, forming a split-phase output circuit. Meanwhile, switching-off of the third switch unit 63 and the fourth switch unit 64 physically isolates the first output interface 30 and the second output interface 40, preventing the first output interface 30 and the second output interface 40 from being erroneously connected to the split-phase circuit in this mode, thereby ensuring safe operation of the energy storage system 1000 and eliminating a risk of interference between the ports. Reliability, flexibility, and safety of multi-mode switching are significantly enhanced in this switch configuration.

In an exemplary embodiment, the second switch unit 62 includes a fourth switch K4, a fifth switch K5, and a sixth switch K6. An end of the fourth switch K4 is connected to the live terminal of the first alternating current-direct current conversion module 10, and another end of the fourth switch K4 is connected to the first connection terminal L1. An end of the fifth switch K5 is connected to a neutral terminal of the second alternating current-direct current conversion module 20, and another end of the fifth switch K5 is connected to a neutral terminal of the third output interface 50. An end of the sixth switch K6 is connected to a live terminal of the second alternating current-direct current conversion module 20, and another end of the sixth switch K6 is connected to the second connection terminal L2 of the third output interface 50. The third switch unit 63 includes a seventh switch K7 and an eighth switch K8. An end of the seventh switch K7 is connected to the live terminal of the first alternating current-direct current conversion module 10 and the second switch K2, and another end of the seventh switch K7 is connected to a live terminal of the first output interface 30. An end of the eighth switch K8 is connected to the third switch K3 and a neutral terminal of the second alternating current-direct current conversion module 20, and another end of the eighth switch K8 is connected to a neutral terminal of the first output interface 30. The fourth switch unit 64 includes a ninth switch K9. An end of the ninth switch K9 is connected to a live terminal of the second alternating current-direct current conversion module 20, and another end of the ninth switch K9 is connected to a live terminal of the second output interface 40.

The control module may further be connected to the fourth switch K4, the fifth switch K5, the sixth switch K6, the seventh switch K7, the eighth switch K8, and the ninth switch K9, respectively, to control switching-on and switching-off of each of the fourth switch K4, the fifth switch K5, the sixth switch K6, the seventh switch K7, the eighth switch K8, and the ninth switch K9.

In the first state, the control module can control the first switch K1, the second switch K2, the third switch K3, the fourth switch K4, the fifth switch K5, and the sixth switch K6 to be switched off, and control the seventh switch K7 and/or the ninth switch K9, as well as the eighth switch K8, to be switched on. In the second state, the control module can control the second switch K2 and the third switch K3 to be switched off, control any one of the first switch K1, the seventh switch K7, or the ninth switch K9 to be switched off, and control the fourth switch K4, the fifth switch K5, and the sixth switch K6 to be switched on.

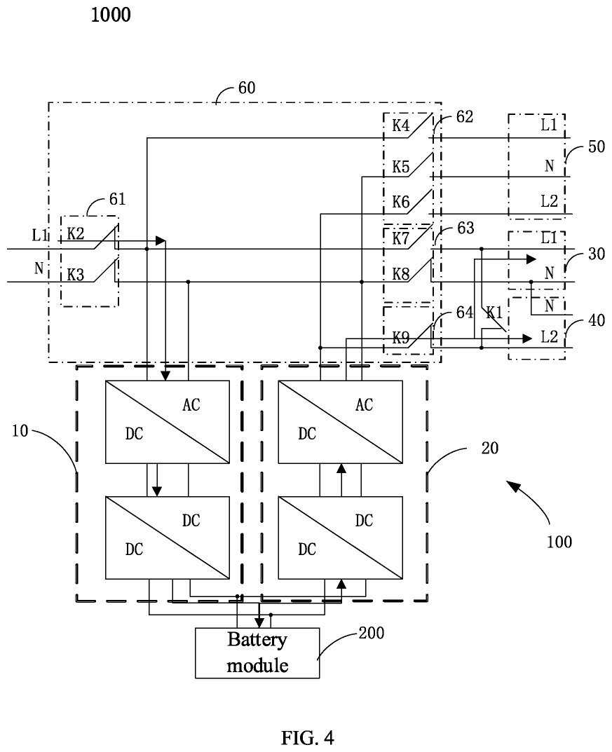

Referring to FIG. 4, in some embodiments, the first alternating current-direct current conversion module 10 is further electrically connected to the second alternating current-direct current conversion module 20. In the third state, the first switch unit 61, the eighth switch K8 of the third switch unit 63, and the fourth switch unit 64 are switched on, the third alternating current supplied from the alternating current power supply is inverted into a first direct current by the first alternating current-direct current conversion module 10, the first direct current is inverted into the second alternating current by the second alternating current-direct current conversion module 20, and the second alternating current is outputted to the second output interface 40 and/or the first output interface 30 through the fourth switch unit 64 and/or the first switch K1.

In the third state, the external alternating current power supply can charge the battery module 200 through the first alternating current-direct current conversion module and the second alternating current-direct current conversion module while supplying the single-phase alternating current to the load. That is, the external alternating current power supply charges the battery module 200 through the alternating current-direct current conversion modules while supplying power to the load. In an exemplary embodiment, the control module can control the second switch K2, the third switch K3, the eighth switch K8, and the ninth switch K9 to be switched on, enabling the external alternating current power supply to charge the battery module 200 through the first alternating current-direct current conversion module 10. Meanwhile, the current is converted into the alternating current by the second alternating current-direct current conversion module 20, and the single-phase alternating current is then outputted through the second output interface 40. Moreover, the control module can also control the first switch K1 or the seventh switch K7 to be switched on, enabling the single-phase alternating current to be outputted through the first output interface 30.

In this way, in the third state of the power supply circuit 100, the first switch unit 61, the eighth switch K8 of the third switch unit 63, and the fourth switch unit 64 are switched on, along with the coordinated operation of the first alternating current-direct current conversion module 10 and the second alternating current-direct current conversion module 20, efficient utilization of the utility power and flexible power allocation are realized. The connected alternating current power supply (the third alternating current) is rectified into the first direct current by the first alternating current-direct current conversion module 10. This first direct current can not only charge the energy storage battery, but can also be shared with the second alternating current-direct current conversion module 20. The received first direct current is re-inverted into the second alternating current by the second alternating current-direct current conversion module 20, and then the second alternating current is outputted to the second output interface 40 and/or the first output interface 30 through the switched-on fourth switch unit 64 and/or the switched-on first switch K1. In this way, an upper limit of output power and power supply flexibility in a scenario where the utility power is available are significantly increased, while providing an energy source for battery charging.

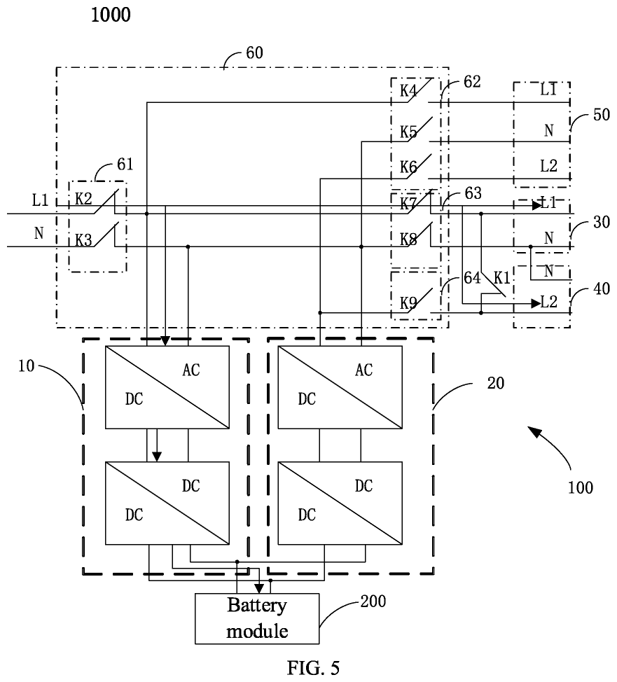

Referring to FIG. 5, in some embodiments, in a fourth state, the first switch unit 61, the second switch unit 62, and the third switch unit 63 are switched on, the third alternating current is supplied to the third output interface 50 and the first alternating current-direct current conversion module 10 from the alternating current power supply, and the first alternating current-direct current conversion module 10 is further configured to generate a first direct current from the third alternating current.

In the fourth state, the external alternating current power supply can charge the battery module 200 while directly supplying the single-phase alternating current to the load through the output interface. In an exemplary embodiment, the control module can control the second switch K2, the third switch K3, the seventh switch K7, and the eighth switch K8 to be switched on, enabling the external alternating current power supply to charge the battery module 200 through the first alternating current-direct current conversion module 10 while directly outputting the single-phase alternating current through the first output interface 30. Moreover, the control module can also control the first switch K1 to be switched on, enabling the single-phase alternating current to be outputted through the second output interface 40.

In this way, in the fourth state, parallel processing of direct utility power supply to critical load and charging of the energy storage system 1000 is realized by the power supply circuit 100. A net third alternating current is directly supplied to the third output interface 50 without conversion from the external alternating current power supply through the switched-on first switch unit 61 and the switched-on second switch unit 62, ensuring the highest power supply quality and efficiency for a load connected to this interface. Meanwhile, the utility power is also supplied to the first alternating current-direct current conversion module 10, and rectified into the first direct current by the first alternating current-direct current conversion module 10 to charge the battery module 200. In this way, on the premise of prioritizing direct supply of high-quality utility power to the third output interface 50, the utility power is simultaneously used to charge the battery module 200, which optimizes utilization efficiency of the utility power and provides an optimal power supply solution for a load that requires stable utility power or is sensitive to power quality.

While the specific embodiments of the present disclosure have been described above, the scope of the present disclosure is not limited to these embodiments. Various modifications and alternatives can be easily conceived by any of those skilled in the art without departing from the scope of the present disclosure. Therefore, these modifications and alternatives are to be encompassed by the scope of the present disclosure as defined by the appended claims.

What is claimed is:

1. A power supply circuit, comprising:
a first alternating current-direct current conversion module configured to generate a first alternating current;
a second alternating current-direct current conversion module configured to generate a second alternating current;
a first output interface configured to be electrically connected to the first alternating current-direct current conversion module;
a second output interface configured to be electrically connected to the second alternating current-direct current conversion module and connected to the first output interface by a first switch; and
a third output interface having a first connection terminal and a second connection terminal, wherein the first connection terminal is connectable to the first alternating current-direct current conversion module, and wherein the second connection terminal is connectable to the second alternating current-direct current conversion module, wherein:
in a first state, the first switch is switched on, the first alternating current and the second alternating current have the same amplitude without a phase difference between the first alternating current and the second alternating current, the first alternating current and the second alternating current are outputted through the first output interface and/or the second output interface, and the third output interface is disconnected from the first alternating current-direct current conversion module and the second alternating current-direct current conversion module; and
in a second state, the first switch is switched off, the first output interface is electrically disconnected from the first alternating current-direct current conversion module or the second output interface is electrically disconnected from the second alternating current-direct current conversion module, the phase difference exists between the first alternating current and the second alternating current, the third output interface is connected to both the first alternating current-direct current conversion module and the second alternating current-direct current conversion module, and the first alternating current and the second alternating current are outputted through the third output interface.

2. The power supply circuit according to claim 1, further comprising a switch module comprising a first switch unit, wherein an end of the first switch unit is connected to an alternating current power supply, and another end of the first switch unit is connected to the first output interface, the second output interface, and the first alternating current-direct current conversion module,
wherein when the first switch unit is switched on, a third alternating current is supplied to the first output interface, the second output interface, and the first alternating current-direct current conversion module from the alternating current power supply via the first switch unit.

3. The power supply circuit according to claim 2, wherein the switch module further comprises:
a second switch unit, wherein an end of the second switch unit is connected to the first alternating current-direct current conversion module and the second alternating current-direct current conversion module, and another end of the second switch unit is connected to the third output interface;
a third switch unit, wherein an end of the third switch unit is connected to the first alternating current-direct current conversion module, and another end of the third switch unit is connected to the first output interface; and
a fourth switch unit, wherein an end of the fourth switch unit is connected to the second alternating current-direct current conversion module, and another end of the fourth switch unit is connected to the second output interface, wherein:
in the first state, the second switch unit is switched off, and the third switch unit and/or the fourth switch unit are switched on; and
in the second state, the second switch unit is switched on.

4. The power supply circuit according to claim 3, wherein the first alternating current-direct current conversion module is further electrically connected to the second alternating current-direct current conversion module,
wherein in a third state, the first switch unit and the fourth switch unit are switched on, the third alternating current supplied from the alternating current power supply is rectified into a first direct current by the first alternating current-direct current conversion module, the first direct current is inverted into the second alternating current by the second alternating current-direct current conversion module, and the second alternating current is outputted to the second output interface and/or the first output interface through the fourth switch unit and/or the first switch.

5. The power supply circuit according to claim 3, wherein in a fourth state, the first switch unit and the third switch unit are switched on, the third alternating current is supplied to the first output interface and the first alternating current-direct current conversion module from the alternating current power supply, and the first alternating current-direct current conversion module is further configured to generate a first direct current from the third alternating current.

6. The power supply circuit according to claim 3, wherein the first switch unit comprises:
a second switch, wherein an end of the second switch is connected to a live terminal of the alternating current power supply, and another end of the second switch is connected to a live terminal of the first alternating current-direct current conversion module and the third switch unit; and
a third switch, wherein an end of the third switch is connected to a neutral terminal of the alternating current power supply, and another end of the third switch is connected to a neutral terminal of the first alternating current-direct current conversion module and the third switch unit.

7. The power supply circuit according to claim 6, wherein the second switch unit comprises:
a fourth switch, wherein an end of the fourth switch is connected to the live terminal of the first alternating current-direct current conversion module, and another end of the fourth switch is connected to the first connection terminal;
a fifth switch, wherein an end of the fifth switch is connected to a neutral terminal of the second alternating current-direct current conversion module, and another end of the fifth switch is connected to a neutral terminal of the third output interface; and
a sixth switch, wherein an end of the sixth switch is connected to a live terminal of the second alternating current-direct current conversion module, and another end of the sixth switch is connected to the second connection terminal of the third output interface.

8. The power supply circuit according to claim 6, wherein the third switch unit comprises:
a seventh switch, wherein an end of the seventh switch is connected to the live terminal of the first alternating current-direct current conversion module and the second switch, and another end of the seventh switch is connected to a live terminal of the first output interface; and
an eighth switch, wherein an end of the eighth switch is connected to the third switch and a neutral terminal of the second alternating current-direct current conversion module, and another end of the eighth switch is connected to a neutral terminal of the first output interface.

9. The power supply circuit according to claim 6, wherein the fourth switch unit comprises:
a ninth switch, wherein an end of the ninth switch is connected to a live terminal of the second alternating current-direct current conversion module, and another end of the ninth switch is connected to a live terminal of the second output interface.

10. The power supply circuit according to claim 1, wherein in the second state, the first alternating current and the second alternating current have the same amplitude, and the phase difference between the first alternating current and the second alternating current ranges from 90° to 180°.

11. The power supply circuit according to claim 10, wherein in the second state, the first alternating current and the second alternating current have the same amplitude, and the phase difference between the first alternating current and the second alternating current is 180°.

12. The power supply circuit according to claim 5, wherein in the fourth state, the second switch unit is switched on, and the third alternating current is supplied to the third output interface from the alternating current power supply.

13. An energy storage system, comprising:
the power supply circuit according to claim 1; and
a battery module, wherein:
the first alternating current-direct current conversion module and the second alternating current-direct current conversion module are electrically connected to the battery module; and
the first alternating current-direct current conversion module and the second alternating current-direct current conversion module are configured to provide a direct current power supply to the battery module, or the battery module is configured to output an alternating current through the first alternating current-direct current conversion module and the second alternating current-direct current conversion module.

14. The energy storage system according to claim 13, wherein the power supply circuit comprises further a switch module comprising a first switch unit, wherein an end of the first switch unit is connected to an alternating current power supply, and another end of the first switch unit is connected to the first output interface, the second output interface, and the first alternating current-direct current conversion module,
wherein when the first switch unit is switched on, a third alternating current is supplied to the first output interface, the second output interface, and the first alternating current-direct current conversion module from the alternating current power supply via the first switch unit.

15. The energy storage system according to claim 14, wherein the switch module further comprises:
a second switch unit, wherein an end of the second switch unit is connected to the first alternating current-direct current conversion module and the second alternating current-direct current conversion module, and another end of the second switch unit is connected to the third output interface;
a third switch unit, wherein an end of the third switch unit is connected to the first alternating current-direct current conversion module, and another end of the third switch unit is connected to the first output interface; and
a fourth switch unit, wherein an end of the fourth switch unit is connected to the second alternating current-direct current conversion module, and another end of the fourth switch unit is connected to the second output interface, wherein:
in the first state, the second switch unit is switched off, and the third switch unit and/or the fourth switch unit are switched on; and
in the second state, the second switch unit is switched on.

16. The energy storage system according to claim 15, wherein the first alternating current-direct current conversion module is further electrically connected to the second alternating current-direct current conversion module,
wherein in a third state, the first switch unit and the fourth switch unit are switched on, the third alternating current supplied from the alternating current power supply is rectified into a first direct current by the first alternating current-direct current conversion module, the first direct current is inverted into the second alternating current by the second alternating current-direct current conversion module, and the second alternating current is outputted to the second output interface and/or the first output interface through the fourth switch unit and/or the first switch.

17. The energy storage system according to claim 15, wherein in a fourth state, the first switch unit and the third switch unit are switched on, the third alternating current is supplied to the first output interface and the first alternating current-direct current conversion module from the alternating current power supply, and the first alternating current-direct current conversion module is further configured to generate a first direct current from the third alternating current.

18. The energy storage system according to claim 15, wherein the first switch unit comprises:
a second switch, wherein an end of the second switch is connected to a live terminal of the alternating current power supply, and another end of the second switch is connected to a live terminal of the first alternating current-direct current conversion module and the third switch unit; and
a third switch, wherein an end of the third switch is connected to a neutral terminal of the alternating current power supply, and another end of the third switch is connected to a neutral terminal of the first alternating current-direct current conversion module and the third switch unit.

19. The energy storage system according to claim 18, wherein the second switch unit comprises:
a fourth switch, wherein an end of the fourth switch is connected to the live terminal of the first alternating current-direct current conversion module, and another end of the fourth switch is connected to the first connection terminal;
a fifth switch, wherein an end of the fifth switch is connected to a neutral terminal of the second alternating current-direct current conversion module, and another end of the fifth switch is connected to a neutral terminal of the third output interface; and
a sixth switch, wherein an end of the sixth switch is connected to a live terminal of the second alternating current-direct current conversion module, and another end of the sixth switch is connected to the second connection terminal of the third output interface.

20. The energy storage system according to claim 18, wherein the third switch unit comprises:
a seventh switch, wherein an end of the seventh switch is connected to the live terminal of the first alternating current-direct current conversion module and the second switch, and another end of the seventh switch is connected to a live terminal of the first output interface; and
an eighth switch, wherein an end of the eighth switch is connected to the third switch and a neutral terminal of the second alternating current-direct current conversion module, and another end of the eighth switch is connected to a neutral terminal of the first output interface.
